(19) United States
(12) Patent Application Publication
(10) Pub. No.: US 2005/0090611 A1
(43) Pub. Date: Apr. 28, 2005

(54) Hydrophilic emulsifiers based on polyisobutylene

(76) Inventors: Stephan Huffer, Ludwigshafen (DE); Gregor Schurmann, Schwetzingen (DE); Ralf Norenberg, Buttelborn (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/490,852

(22) PCT Filed: Sep. 25, 2002
(86) PCT No.: PCT/EP02/10769

(30) Foreign Application Priority Data
Sep. 27, 2001 (DE) 101 47 650.7

(51) Int. Cl. C08F 10/10; C08K 3/00

(52) U.S. Cl. 524/800; 523/122

(57) ABSTRACT

The invention relates to amphiphilic compounds and mixtures thereof and processes for their preparation and their use in oil-in-water emulsions. The compounds are composed of a lipophilic and a hydrophilic part. The two parts are linked to one another by a linker derived from succinic acid. The lipophilic part is formed by a polyisobutylene group having a number average molecular weight Mₙ of from 300 to 10 000. The hydrophilic part preferably comprises at least two polyethylene glycol chains which can be prepared by reacting —OH, —N(H)— and/or —NH₂ with ethylene oxide. A globular, nonlinear structure of the hydrophilic part is thus obtained, so that the hydrophilic character of the novel compounds predominate and said compounds are particularly suitable for oil-in-water emulsions. The invention additionally relates to formulations for treating metal surfaces, especially for corrosion protection, comprising at least one compound of the invention, at least one solvent capable of dissolving, dispersing, suspending or emulsifying the compound/s of the invention, and, if desired, further components. The process is for treating metal surfaces by contacting them with the formulation of the invention, and also coated metal surfaces themselves, are likewise provided by the present invention.

The present invention relates to compounds based on polyisobutylene and mixtures thereof which are suitable as emulsifiers for oil-in-water emulsions, processes for the preparation of such compounds and the emulsions themselves. The invention further relates to formulations comprising the compounds of the invention and also to their use in corrosion protection and to processes for treating metal surfaces with the compounds and/or formulations of the invention.

The prior art discloses compounds of various types having emulsifier properties. Inter alia, derivatives of succinic anhydride substituted by a polyisobutylenyl group are used in various applications. However, since their lipophilic character generally predominates, they are used as emulsifiers for water-in-oil emulsions, in particular for water-in-fuel emulsions, and scarcely for oil-in-water emulsions.

The non-prior-published DE-A 100 03 105 of earlier priority date describes the use of alkoxylated polyisobutylenes as emulsifiers in water-in-fuel emulsions. These alkoxylated polyisobutylenes can be described by the general formula R(—CH₂)ₙ(—O-A)ₘ-OH. Here, R is a polyisobutylene having a weight average molar mass of from 300 to 2 300, preferably from 500 to 2 000. A is an alkylene radical of 2 to 8 carbon atoms. The number m is from 1 to 200 and is chosen so that the alkoxylated polyisobutylene contains from 0.2 to 1.5 alkylene oxide units, preferably 0.5 alkylene oxide unit, per C₄ unit; n is either 0 or 1.

GB-A 2,157,744 discloses drilling fluids which contain both graft copolymers or block copolymers of polycarboxylic acids and polyethylene glycol and compounds which are prepared from a succinic anhydride substituted by a polyisobutylenyl group, preferably having a number average molecular weight Mₙ of from 400 to 5 000, and polyols, polyamines, hydroxycarboxylic acids or amino alcohols.

U.S. Pat. No. 4,708,753 discloses water-in-fuel emulsions which contain, inter alia, mono- or diamine salts of succinic acid or monoamine salts of succinic monoesters or succinic monoamides as emulsifiers. These monoesters or monoamides form as a result of the reaction of alkanolamines, polyamines, oligoalcohols or polyols with succinic anhydrides which are substituted by C₂₀-C₅₀₀-hydrocarbon radicals, such as polyisobutylene groups. In the examples, only the salts of succinic acids and their monoesters and monoamides, which carry a polyisobutylenyl group having a number average molecular weight of 950 or 1 700, are described.

WO 00/15740 discloses water-in-fuel emulsions which contain, as emulsifiers, two succinic acid derivatives which are linked via a linker, such as alkanolamine, polyamine or polyol, and are substituted by hydrocarbon radicals, such as polyisobutylenyl groups, in one example one succinic acid derivative containing a polyisobutylenyl group of 8 to 25 carbon atoms and the other succinic acid derivative containing a polyisobutylenyl group of 50 to 400 carbon atoms.

EP-A 0 156 572 describes the use of surface-active substances (for the preparation of water-in-oil or oil-in-water emulsions) based on succinic acid derivatives which are substituted by polyisobutylenyl groups and preferably have a number average molecular weight Mₙ of from 400 to 5 000. These succinic acid derivatives are reacted, for example, with amino acids, hydroxy acids, polyols, polyamines and alkanolamines and then reacted with phosphoric acid, sulfuric acid or chlorosulfonic acid in order to introduce anionic groups. In addition to phosphate, sulfate and sulfonate groups, phosphonate and carboxymethyl groups are also mentioned as anionic groups. Acidic anionic groups can be neutralized by reaction with NH₃, amines or alkanolamines.

The abovementioned compounds known from the prior art are generally unsuitable or only poorly suitable as emulsifiers for oil-in-water emulsions. They furthermore have various disadvantages with regard to preparation and/or product properties. In the case of some compounds, by-products are obtained in different yields in the synthesis and—unless they are removed—can make it more difficult to establish a constant viscosity of the emulsifier. Disadvantages may also arise in the preparation of emulsions; frequently, the emulsions have insufficient stability so that phase separation occurs during storage. The emulsifiers used must therefore be employed in high concentrations in order to permit the formation of a stable emulsion.

There is therefore a need for compounds which can be used for emulsifiers in oil-in-water emulsions and do not have said disadvantages.

It is an object of the present invention to provide further compounds which can be used as emulsifiers in oil-in-water emulsions.

We have found that this object is achieved by compounds of the formula (I) 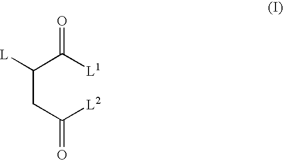
where -L is a polyisobutylenyl group having a number average molecular weight Mₙ of from 300 to 10 000,
-L¹ and -L², independently of one another, are -A¹, -A², —NH₂ or —O⁻M⁺, one of the two being -A¹, or
-L¹ and -L² together are 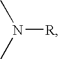
-A¹ is 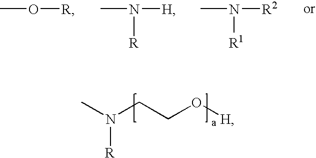
-A² is 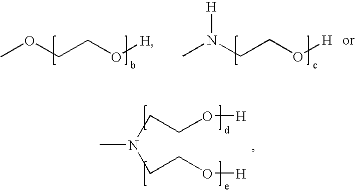
M⁺ is H⁺, an alkali metal cation, 0.5 alkaline earth metal cation, other metal cations or NH₄⁺, it being possible for one or more H to be replaced by C₁-C₄-alkyl radicals in NH₄⁺,
R is a linear or branched saturated C₃-C₁₂-hydrocarbon radical or a cyclic or heterocyclic saturated C₄-C₁₂-hydrocarbon radical which carries at least two building blocks selected from the group 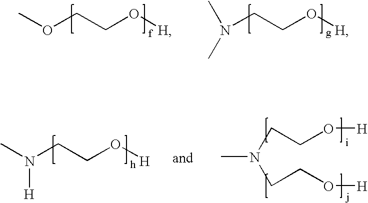
   in the C₃-C₁₂-hydrocarbon chain and
if required, one or more —OH, —NH₂, —NH₃⁺ and/or —C(H)O in the C₃-C₁₂-hydrocarbon chain and/or contains one or more nonneighboring —O— and/or —N(H)—,
it being possible for one or more H to be replaced by C₁-C₄-alkyl radicals in —N(H)—, —NH₂ or —NH₃⁺,
R¹ and R², independently of one another, are a linear saturated C₂-C₁₂-hydrocarbon radical or a branched saturated C₃-C₁₂-hydrocarbon radical,
the two hydrocarbon radicals together carrying at least two building blocks selected from the group 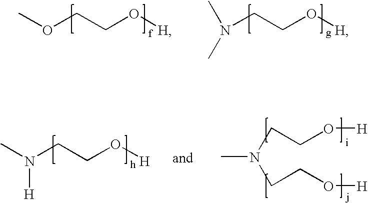
   in the C₂-C₁₂-hydrocarbon chain and, if required, one or more —OH, —NH₂, —NH₃⁺ and/or —C(H)O in the C₂-C₁₂-hydrocarbon chain and/or containing one or more nonneighboring —O— and/or —N(H)—,
and it being possible for one or more H to be replaced by C₁-C₄-alkyl radicals in —N(H), —NH₂ or —NH₃⁺, and
a, b, c, d, e, f, g, h, i and j in the individual building blocks are identical or different and are integers from 1 to 50.

The further metal cations can be, for example, cations of the metals zinc, zirconium, titanium, tungsten and vanadium—in suitable form. Specific examples, though not intended to be limiting, are Zn²⁺ and ZrO²⁺.

Compounds of the formula (I), in which -L¹ and L² together are 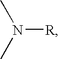
are generally present as a mixture with the corresponding open-chain monoamides—compounds of the formula (I) in which one of the two substituents -L¹ and -L² is —OH and the other —N(H)R.

The present invention likewise relates to compounds of the formula (II) 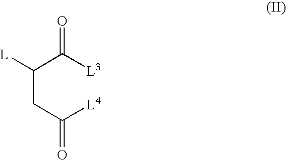
where -L is a polyisobutylenyl group having a number average molecular weight Mₙ of from 300 to 10 000,
-L³ and -L⁴, independently of one another, are 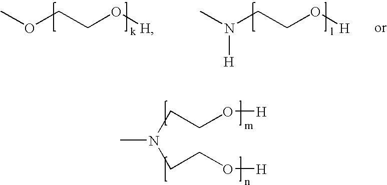
   and
k, l and the sum of m and n in the individual units are identical or different and are integers from 4 to 50.

The present invention likewise relates to compounds of the formula (V) 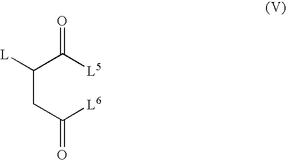
where -L is a polyisobutylenyl group having a number average molecular weight Mₙ of from 300 to 10 000,
-L⁵ and -L⁶, independently of one another, are selected from the group consisting of —O⁻M⁺, 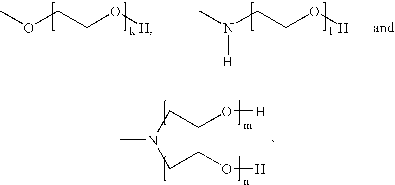
   with one of the two radicals -L⁵ and -L⁶ being —O⁻M⁺,
M⁺ being H⁺, an alkali metal cation, 0.5 alkaline earth metal cation, further metal cations or NH₄⁺, and it being possible for one or more H to be replaced by C₁-C₄-alkyl radicals in NH₄⁺, and
k, l and the sum of m and n in the individual units are identical or different and are integers from 4 to 50.

The further metal cations can be, for example, cations of the metals zinc, zirconium, titanium, tungsten and vanadium—in suitable form. Specific examples, though not intended to be limiting, are Zn²⁺ and ZrO²⁺.

The compounds of the formulae (I), (II) and (V) may be used both individually and as a mixture of those of the formula (I) with those of the formula (II) and as a mixture of those of the formula (I) and as a mixture of those of the formula (II), and may be used wherever an efficient reduction of the surface tension and sufficient chemical stability are required. The present invention therefore relates to their use for the preparation of emulsions for metal processing (as components of cutting oils) and for emulsion polymerization, their use as surfactants in place of fluorine surfactants in electroplating, their use for rendering metal surfaces water-repellent, their use as antifoams and as solubilizers for oils in detergent and cleaning formulations or for solubilizing fragrances (perfumes) and care oils for cosmetic applications (hair care compositions, such as shampoo), etc. The novel compounds of the formulae (I), (II) and/or (V) can moreover be used in the tanning or washing and degreasing of leather in place of alkylphenol ethoxylates, in particular of nonylphenol ethoxylates, and as wetting agents for water-based surface coatings, finishes and adhesives. A further field of use of the compounds of the invention is the treatment of metal surfaces, especially for corrosion protection (see below).

The novel compounds are amphiphilic, the hydrophilic character predominating. The lipophilic part is formed by the polyisobutylene group, which is linked to the hydrophilic part via the linker succinic acid. This hydrophilic part is distinguished by the fact that, instead of a linear polyethylene glycol chain, a plurality of polyethylene glycol chains (at least two thereof) is present. This results in a globular, nonlinear structure of the hydrophilic part.

Among the novel compounds of the formula (I), preferred compounds are those in which
i) the proportion of A¹+A² in the compound of the formula (I) is at least 15, preferably 30, particularly preferably from 40 to 60, % by weight, and/or
ii) L is a polyisobutylenyl group having a number average molecular weight Mₙ of from 300 to 1 200 (low molecular weight compounds), in particular from 300 to 1 000, particularly preferably from 350 to 950, very particularly preferably from 350 to 750, or is a polyisobutylenyl group having a number average molecular weight Mₙ of from 2 000 to 10 000 (high molecular weight compounds), in particular from 2 000 to 5 500, particularly preferably from 2 200 to 4 500, and/or
iii1) one of the two substituents -L¹ and -L² is —O⁻M⁺ and the other is —O—R, —N(H)R or —NR¹R² and
   R is a linear or branched saturated C₄-C₁₂-hydrocarbon radical which carries from 3 to 10 substituents selected from the group consisting of —O[CH₂—CH₂—O]_{f}H and —N(H)[CH₂—CH₂—O—]ₕH and, if required,
   one or more —OH, —NH₂ and/or —C(H)O and/or
   contains one or more —O— and/or —N(H)—, and
   f and h in the individual substituents are identical or different and are integers from 1 to 10 or
   R¹ and R², independently of one another, are two linear or branched saturated hydrocarbon radicals having a total of 4 to 12 carbon atoms or which together carry a total of from 3 to 10 substituents selected from the group consisting of —O[CH₂—CH₂—O—]_{f}H and —N(H)[CH₂CH₂—O—]ₕH and, if required,
   one or more —OH, —NH₂ and/or —C(H)O and/or
   contain one or more —O— and/or —N(H)—, and
   f and h in the individual substituents are identical or different and are integers from 1 to 10, or
iii2) -L¹ and -L² together are 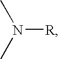
   where
   R is a linear or branched saturated C₄-C₁₂-hydrocarbon radical which carries from 3 to 10 substituents selected from the group consisting of —O[CH₂—CH₂—O—]_{f}H and —N(H)[CH₂—CH₂—O—]ₕH and, if required,
   one or more —OH, —NH₂ and/or —C(H)O and/or
   contains one or more —O— and/or —N(H)—, and
   f and h in the individual substituents are identical or different and are integers from 1 to 10.
      Compounds of the Formula (I)
j) in which one of the two substituents -L¹ and -L² is —O⁻M⁺ and the other is —O—R or —N(H)R and
   R is a linear or branched saturated C₄-C₁₂-hydrocarbon radical which carries from 3 to 10, in particular from 3 to 6, —O[CH₂—CH₂—O—]_{f}H substituents and, if required, one or more —OH and/or —C(H)O,
   where f in the individual —O[CH₂—CH₂—O—]_{f}H substituents are identical or different and are an integer from 1 to 10, or
jj) in which -L¹ and -L² together are 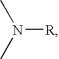
   and
   R is a linear or branched saturated C₄-C₁₂-hydrocarbon radical which carries from 3 to 10, in particular from 3 to 6, —O[CH₂—CH₂—O—]_{f}H substituents and, if required, one or more —OH and/or —C(H)O,
   f in the individual —O[CH₂—CH—O—]_{f}H-substituents being identical or different and being an integer from 1 to 10,
      are particularly preferred.

Of the compounds of the formulae (II) and (V) preference is given to those compounds—particularly for use in corrosion protection—wherein
at least one of the two radicals L³ and L⁴ or L⁵ and L⁶ is not O⁻M⁺, in other words the monoesters and monoamides and/or the diesters and diamides, and/or
the fraction of L³+L⁴ in the compound of the formula (II) or the fraction of L⁵+L⁶ in the compound of the formula (V) is at least 15% by weight, preferably 30% by weight, particularly preferably from 40 to 60% by weight, and/or
L is a polyisobutylenyl group having a number average molecular weight Mₙ of from 300 to 1 200 (low molecular weight compounds), in particular from 300 to 1 000, particularly preferably from 350 to 950, very particularly preferably from 350 to 750, or is a polyisobutylenyl group having a number average molecular weight Mₙ of from 2 000 to 10 000 (high molecular weight compounds), in particular from 2 000 to 5 500, particularly preferably from 2 200 to 4 500.

Particular preference is given to the monoesters and monoamides, i.e. the compounds of the formula (V) where M⁺ is particularly H⁺ or NH₄⁺, it being possible for one or more H to be replaced by C₁-C₄-alkyl radicals in NH₄⁺.

Of the last-mentioned monoesters and monoamides, preference is given in turn to those in which one of the two radicals L⁵ and L⁶ is selected from the group consisting of 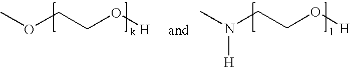
and/or is M⁺H⁺ or NH₄⁺, it being possible for one or more H to be replaced by C₁-C₄-alkyl radicals in NH₄⁺. Of the last-mentioned compounds, particular preference is given to those in which -L⁵ is —O⁻M⁺, especially with M⁺=H⁺ or NH₄⁺, it being possible for one or more H to be replaced by C₁-C₄-alkyl radicals in NH₄⁺.

The present invention also relates to processes for the preparation of the compounds of the formula (I) which contain the following process steps:
a) reaction of polyisobutylene with fumaryl dichloride, fumaric acid, maleyl dichloride, maleic acid or maleic anhydride to give compounds of the formula (IIIa), (IIIb) or (IIIc), 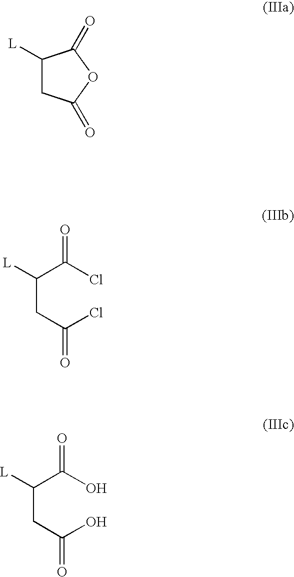
b) reaction of the compounds of the formula (IIIa), (IIIb) or (IIIc) which are obtained by step a) with a polar reactant selected from the group consisting of R*OH, R*NH₂ and R¹*R²*NH and
c) reaction of the reaction products obtained by step b) with ethylene oxide, and
d) if required, hydrolysis of —COCl present to —CO₂H, and
e) if required, conversion of —CO₂H and/or —COCl present with NH₃, amines or metal, alkali metal or alkaline earth metal salts into the corresponding salts,
where R* is a linear or branched saturated C₃-C₁₂-hydrocarbon radical or is a cyclic or heterocyclic saturated C₄-C₁₂-hydrocarbon radical which contains at least two building blocks selected from the group consisting of —OH, —N(H)— and —NH₂ and, if required, carries one or more —NH₃⁺ and/or —C(H)O and/or contains one or more nonadjacent —O—,
R¹* and R²*, independently of one another, are a linear saturated C₂-C₁₂-hydrocarbon radical or are a branched saturated C₃-C₁₂-hydrocarbon radical, the two hydrocarbon radicals together containing at least two building blocks selected from the group consisting of —OH, —N(H)— and —NH₂ and,
if required, carrying one or more —NH₃⁺ and/or —C(H)O and/or containing one or more nonneighboring —O—,
although it being possible to replace one or more H in the —N(H)—, —NH₂ and/or —NH₃⁺ by C₁-C₄-alkyl radicals, it still being necessary for at least two building blocks selected from the group consisting of —OH, —N(H)— and —NH₂ to be present as such.

The reaction of polyisobutylene with fumaric acid, maleic acid or the above-mentioned derivatives thereof is effected by processes known to a person skilled in the art. For example, the reaction is effected analogously to the processes for the reaction of polyisobutylenes with maleic anhydride, which are described in DE-A 195 19 042, DE-A 43 19 671 and DE-A 43 19 672. The reaction with maleic anhydride is preferred.

Since, in the reaction with maleic anhydride, a new double bond which may likewise react with maleic anhydride is formed, the succinic anhydrides thus obtained and substituted by a polyisobutylene group generally have a ratio of from 0.9 to 1.5, preferably from 0.9 to 1.1, succinic anhydride groups per polyisobutylene chain. Particularly preferably, each polyisobutylene chain carries only one succinic anhydride group.

By reaction of the substituted succinic acid derivatives of the formula (IIIa), (IIIb) or (IIIc) with a polar reactant (step b) of the novel process), succinic monoesters or succinic monoamides are obtained—if necessary with opening of the lactone ring (compound (IIIa)).

Suitable polar reactants R*OH, R*NH₂ and R¹*R²*NH are alkanolamines, oligoamines, polyamines, oligoalcohols, polyols and monosaccharides, disaccharides and hydroxycarboxylic acids which carry at least 3, preferably from 4 to 11, particularly preferably from 4 to 7, building blocks selected from the group consisting of —OH, —N(H)— and —NH₂ and, if required, one or more —NH₃⁺ and/or —C(H)O and/or contain nonneighboring —O—. Here, one or more H in the —N(H)—, —NH₂ and/or —NH₃⁺ can be replaced by C₁-C₄-alkyl radicals. However, it must be ensured that at least 3 building blocks selected from the group consisting of —OH, —N(H)— and —NH₂, which are capable of reacting with ethylene oxide or the succinic anhydride, are still present.

When alkanolamines are used, the hydroxyl and/or amino groups react so that in general mixtures of succinic monoesters and succinic monoamides are obtained.

The reaction ratio of the substituted succinic acid derivatives (IIIa), (IIIb) or (IIIc) to the polar reactants R*OH, R*NH₂ and R¹*R²*NH is in general from 1:(0.75 to 2), preferably 1:(0.8 to 1.2), particularly preferably 1:1.

A reaction of the reaction products with ethylene oxide (step c)) is then effected, with the result that polyethylene glycol chains are synthesized. Here, the —OH, —N(H)— and/or —NH₂ present (in the linked polar reactants) are converted into 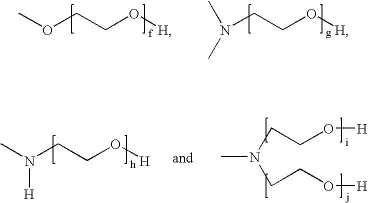
where f, g, h, i and j in the individual building blocks are identical or different and are integers from 1 to 50, preferably from 1 to 10. Under certain circumstances, the CO₂H groups present and/or any amide nitrogens present in the substituted succinic acid derivatives can also react with ethylene oxide—to give compounds of the formula (I) in which -A² is 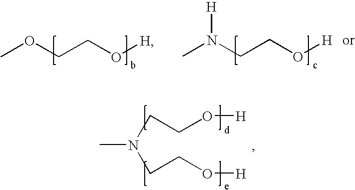
where b, c, d and e are identical or different and are integers from 1 to 50, preferably from 1 to 10.

The amount of ethylene oxide is chosen according to the desired length of the polyethylene glycol chain and is in general from 5 to 50 mol of ethylene oxide/kg of succinic acid derivative. In general, mixtures of compounds of the formula (I) which have polyethylene glycol chains of different lengths are obtained. The amount of ethylene oxide is preferably chosen so that the proportion of the hydrophilic radical A¹+A² in the compound of the formula (I) is at least 15, preferably 30, particularly preferably from 40 to 60, % by weight.

If maleyl or fumaryl dichloride is used as a starting material, the —COCl still present after said reaction steps a) to c) may be hydrolyzed to —CO₂H (step d)).

However, the —COCl present, as well as —CO₂H present, can also be reacted directly with NH₃, amines, alkali metal salts, alkaline earth metal salts or other metal salts to give the corresponding salts (step e)).

In general, polyisobutylenes having a number average molecular weight Mₙ of from 300 to 10 000, preferably from 300 to 1 200 or from 2 000 to 10 000, particularly preferably from 300 to 1 000 or from 2 000 to 5 500, very particularly preferably from 350 to 950 or from 2 200 to 4 500, are used in step a) of the process for the preparation of the compounds of the formula (I).

Preferably used polyisobutylenes having a number average molecular weight Mₙ in said ranges are those which have a high content of vinylidene groups. In the context of the present invention, this is understood as meaning a proportion of vinylidene groups of ≧70, preferably ≧80, particularly preferably ≧85, mol %.

Particularly preferably used polyisobutylenes are those which have a number average molecular weight Mₙ in the abovementioned ranges, a high content of vinylidene groups and a uniform polymer skeleton structure. In the context of the present invention, this is understood as meaning polyisobutylenes which are composed of at least 80, preferably at least 90, particularly preferably at least 95, % by weight of isobutylene units.

Very particularly preferred polyisobutylenes are those having a number average molecular weight Mₙ in said ranges, a high content of vinylidene groups and a uniform skeleton structure, which have a polydispersity of ≦3.0, preferably from 1.1 to 2.5, particularly preferably from 1.1 to 2.0. Polydispersity is understood as meaning the quotient M_{w}/Mₙ of weight average molecular weight M_{w} and number average molecular weight Mₙ.

Polyisobutylenes having a number average molecular weight Mₙ in said ranges which are substantially composed of isobutylene units and have a high content of vinylidene groups are available, for example, under the trade name Glissopal® from BASF AG, Ludwigshafen, such as Glissopal® 2300 having an Mₙ of 2 300, Glissopal® 1000 having an Mₙ of 1 000 and Glissopal® V 33 having an Mₙ of 550.

Suitable alkanolamines, oligoamines, polyamines, oligoalcohols and polyols which can be used for the preparation of the novel compounds of the formula (I) are described, for example, in WO 00/15740.

Examples of alkanolamines are diethanolamine, 2-amino-2-methyl-1,3-propanediol, 2-amino-2-ethyl-1,3-propanediol, N-(2-hydroxypropyl)-N′-(2-aminoethyl)piperazine, tris-(hydroxymethyl)aminomethane, glucamine, glucosamine, N-(3-aminopropyl)-4-(2-hydroxyethyl)piperidine, N-(2-hydroxyethyl)-1,3-diaminopropane, 1,3-diamino-2-hydroxypropane, N-(2-hydroxyethyl)ethylenediamine, N,N-bis(2-hydroxyethyl)-ethylenediamine, N-(2-hydroxyethoxyethyl)ethylenediamine, 1-(2-hydroxy-ethyl)piperazine, monohydroxypropyl-substituted diethylenetriamine, dihydroxypropyl-substituted tetraethylenepentamine and N-(3-hydroxybutyl)tetramethylenediamine.

Salts of said alkanolamines may also be used. In these salts, one or more of the H atoms bonded to the N atoms can, if required, be replaced by C₁-C₄-alkyl groups. However, it must be ensured that—after reaction with a compound of the formula (IIIa), (IIIb) or (IIIc)—at least 2 building blocks (—OH, —N(H)— or —NH₂) which are capable of reacting with ethylene oxide are still present in the molecule.

Suitable oligoamines are linear or branched C₃-C₁₂-alkanes which carry at least three building blocks selected from the group consisting of —N(H)— and —NH₂. Examples are triethylenetetramine, tripropylenetetramine, tetraethylenepentamine, pentaethylene-hexamine and hexaethyleneheptamine.

Examples of suitable polyamines are polyalkylenepolyamines, such as polymethylenepolyamines, polyethylenepolyamines, polypropylenepolyamines, polybutylenepolyamines and polypentylenepolyamines (also see Ethylene Amines in Kirk Othmer's Encyclopedia of Chemical Technology, 2nd Edition, Volume 7, pages 22-37, Interscience Publishers, New York 1965), which have at least three building blocks selected from the group consisting of —N(H)— and —NH₂.

Examples of suitable oligoalcohols and polyols are (mono-, di-)pentaerythritol, 1,2,3-, 1,2,4-, 1,2,5- and 2,3,4-hexanetriol, 1,2,3- and 1,2,4-butanetriol, 2,2,6,6-tetrakis(hydroxy-methyl)cyclohexanol, 2-hydroxymethyl-2-methyl-1,3-propanediol, 2-hydroxymethyl-2-ethyl-1,3-propanediol, sorbitol, mannitol and inositol.

In principle, all monosaccharides are suitable. The C₅- and C₆-aldoses and ketoses, such as glucose and fructose, may be mentioned by way of example.

The reaction with alkanolamines, such as diethanolamine, triethanolamine and tris(hydroxymethyl)aminomethane, oligoalcohols, such as sorbitol and pentaerythritol, and monosaccharides, such as pentoses and hexoses, is preferred.

Suitable amines for the salt formation in step e) of the novel process are primary,
secondary and tertiary amines, which carry linear C₁-C₄-alkyl or branched C₃-C₆-alkyl groups. These alkyl groups may also be substituted by one or more —OH. Examples are diethylamine, diisopropylamine, trimethylamine, mono-, di- and triethanolamine and tris(hydroxymethyl)aminomethane.

Suitable alkali metal and alkaline earth metal salts are the hydroxides and oxides of Li, Na, K, Mg and Ca, and also (complex) salts of Zn, Zr, Ti, W and V. When hydroxides are used, stoichiometric amounts are employed, since otherwise hydrolysis of the succinates occurs.

The present invention also relates to processes for the preparation of the compounds of the formulae (II) and (V) which contain the following process steps: 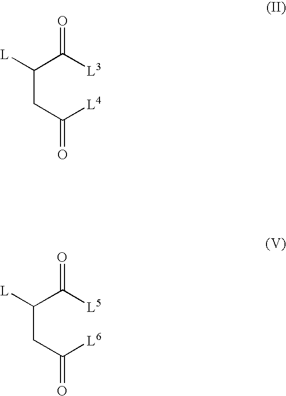
α) reaction of polyisobutylene with fumaryl dichloride, fumaric acid, maleyl dichloride, maleic acid or maleic anhydride to give compounds of the formula (IIIa), (IIIb), (IIIc), 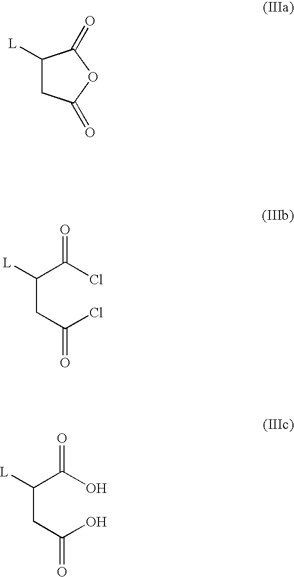
β) if required, reaction of the compounds (IIIa) and (IIIc) with ammonia, ethanolamine or diethanolamine, and
γ) reaction of the compounds obtained by steps α) and β) with ethylene oxide or oligo- or polyethylene glycol,
δ) if required, hydrolysis of —COCl present to —CO₂H,
ε) if required, conversion of —CO₂H and/or —COCl present with NH₃, amines or metal, alkali metal or alkaline earth metal salts into the corresponding salts,
where -L is a polyisobutylenyl group having a number average molecular weight Mₙ of from 300 to 10 000,
-L³ and -L⁴, independently of one another, are 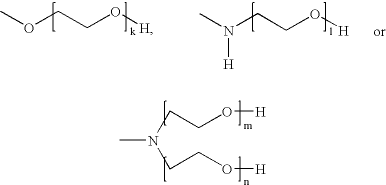
-L⁵ and -L⁶, independently of one another, are selected from the group consisting of —O⁻M⁺, 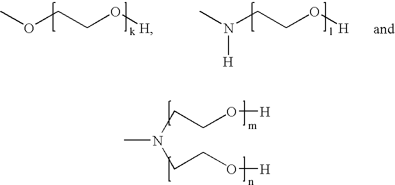
one of the two radicals -L⁵ and -L⁶ being —O⁻M⁺, and M⁺ being H⁺, an alkali metal cation, 0.5 alkaline earth metal cation, further metal cations or NH₄⁺, and it being possible for one or more H to be replaced by C₁-C₄-alkyl radicals in NH₄⁺, and
k, l and the sum of m and n in the individual units are identical or different and are integers from 4 to 50.

Steps α) and γ) are carried out analogously to steps a) and c) of the process described for the preparation of compounds of the formula (I). The reaction with polyethylene glycol is effected by processes known to a person skilled in the art. Depending on the amount of polyethylene glycol used a compound of formula (II) or (V) is obtained The oligo- or polyethylene glycol has from 4 to 50 ethylene glycol units.

The novel compounds and the mixtures thereof can be used in a variety of ways, for example as solubilizers for oils, as antifoams, as water repellents (metals) and generally for the preparation of oil-in-water emulsions. The novel compounds and the mixtures thereof can also be used as chemically inert surfactants in electroplating.

The novel compounds and the mixtures thereof are suitable as emulsifiers for oil-in-water emulsions in which the oil phase is formed by paraffins, mineral oils, vegetable oils, animal oils and fats and/or silicone oils.

The novel compounds and the mixtures thereof are particularly advantageously used as emulsifiers for oil-in-water emulsions in which the oil phase is formed by paraffins, mineral oils and vegetable oils.

In general, the purification of the novel compounds and their intermediates is not necessary; purification may be necessary, for example, only when these compounds are used as emulsifiers for oil-in-water emulsions in the cosmetics or pharmaceutical sector.

The present invention relates to the use of novel compounds and the mixtures thereof as emulsifiers in the preparation of oil-in-water emulsions as well as to the oil-in-water emulsions themselves. Novel oil-in-water emulsions contain in general from 60 to 95% by weight of water, from 3 to 35% by weight of oil and from 0.2 to 10% by weight of at least one novel compound.

In addition to the abovementioned constituents, the oil-in-water emulsions according to the present invention may contain further components. These are, for example, further emulsifiers, such as sodium laurylsulfate, (quaternary) ammonium salts, such as ammonium nitrate, alkylglycosides, lecithins, polyethylene glycol ethers and polyethylene glycol esters, sorbitan oleates, sorbitan stearates and sorbitan ricinolates, C₁₃ oxo alcohol ethoxylates and alkylphenol ethoxylates, and block copolymers of ethylene oxide and propylene oxide, such as the Pluronic® grades from BASF AG, Ludwigshafen. Sorbitan monooleate, C₁₃-oxo alcohol ethoxylates and alkylphenol ethoxylates, for example octyl- and nonylphenol ethoxylates, are preferably used as further emulsifiers.

A combination of one or more of the abovementioned further emulsifiers together with the novel compounds is preferably used for the novel oil-in-water emulsions.

If these further emulsifiers are used, they are employed in amounts of from 0.5 to 5, preferably from 1 to 2.5, % by weight, based on the total composition. The amount of this further emulsifier is chosen so that the total amount of emulsifier does not exceed the amount of from 0.2 to 10% by weight stated for the novel compounds along.

For the preparation of the novel oil-in-water emulsions, the novel compounds are mixed with the water, the oil and the further, optionally usable components and are emulsified in a manner known per se. For example, the emulsification can be effected in a rotor mixer, by means of a mixing nozzle or by means of an ultrasonic probe. Particularly good results were obtained when a mixing nozzle of the type as described in DE-A 198 56 604 was used. Apart from oil-in-water emulsions for emulsion polymerization, it is also possible to prepare oil-in-water emulsions for the cosmetics sector, since the fragrances and care oils can be solubilized.

In addition to their surface-active, interface-active and emulsifying properties, the novel compounds also have corrosion-inhibiting and wear-reducing properties.

Further conventional components—contained in oil-in-water emulsions—are, for example, antioxidants, stabilizers, antiwear additives, dyes and biocides, such as glutaraldehyde or glyoxal.

Examples of stabilizers are those based on amines, such as p-phenylenediamine, dicyclohexylamine or derivatives thereof, or on phenols, such as 2,4-di-tert-butylphenol or 3,5-di-tert-butyl-4-hydroxyphenylpropionic acid.

On the basis of their abovementioned corrosion inhibition properties the compounds of the formulae (I), (II) and (V) can also be employed as anticorrosion agents.

The corrosion of metals represents a problem in the manufacture, processing and use of articles which contain metals. In order to slow down or prevent the corrosion, therefore, protective films and/or corrosion inhibitors are used. While a protective film is applied permanently to the metal, a corrosion inhibitor is usually added to substances—such as liquid mixtures, for example—which if they came into contact with the metal would cause or accelerate corrosion.

In order to possess technical suitability, systems are required to satisfy a series of further requirements in addition to the corrosion inhibition effect. For example, they are to be uniformly applicable to the metal surface and exhibit effective adhesion to it and subsequent enhancement coats; in particular, they should be capable of being overcoated. They ought further to have a good barrier effect toward corrosion-stimulating gases and liquids, exhibit sufficient resistance to mechanical stress and to the effect of moisture, especially electrolyte-containing liquids, and be stable to weathering. In addition the components of the protective film and/or corrosion inhibitors ought to be readily obtainable in sufficient amount and ought also, as far as possible, to be inexpensive.

These requirements are met by the novel compounds of the formulae (I), (II) and (V).

The present invention accordingly likewise relates to formulations for treating metal surfaces, especially for corrosion protection, comprising
A) at least one compound of the formula (I), (II) and/or (V),
B) at least one solvent capable of dissolving, dispersing, suspending or emulsifying component/s A, and
C) if required, further components.

Metal surfaces suitable for application of the formulation of the invention include in general materials customary in industry and selected from the group consisting of alloys of aluminum and of magnesium, iron, steel, copper, zinc, tin, nickel, chromium, and standard industry alloys of these metals. Further suitable metal surfaces are noble metals, particularly gold and silver and their alloys. Suitability extends to metal coatings which are generally common industrially and which may be produced chemically or electro-chemically, selected the group consisting of zinc and its alloys, preferably metallic zinc, zinc/iron, zinc/nickel, zinc/manganese or zinc/cobalt alloys, tin and its alloys, preferably metallic tin, tin alloys containing Cu, Sb, Pb, Ag, Bi and Zn, particularly preferably those used as solders, in the manufacture and processing of circuit boards, for example, and copper, preferably in the form in which it is employed on circuit boards and on metallized plastics parts.

The individual components of the formulation of the invention will be elucidated further below.

Component A

Component A preferably comprises compounds of the formulae (II) and (V). Of the compounds of the formulae (II) and (V) preference is given to the those compounds wherein
at least one of the two radicals L³ and L⁴ or L⁵ and L⁶ is not O⁻M⁺, in other words the monoesters and monoamides and/or the diesters and diamides, and/or
the fraction of L³+L⁴ in the compound of the formula (II) or the fraction of L⁵+L⁶ in the compound of the formula (V) is at least 15% by weight, preferably 30% by weight, particularly preferably from 40 to 60% by weight, and/or
L is a polyisobutylenyl group having a number average molecular weight Mₙ of from 300 to 1 200 (low molecular weight compounds), in particular from 300 to 1 000, particularly preferably from 350 to 950, very particularly preferably from 350 to 750, or is a polyisobutylenyl group having a number average molecular weight Mₙ of from 2 000 to 10 000 (high molecular weight compounds), in particular from 2 000 to 5 500, particularly preferably from 2 200 to 4 500.

Particular preference is given to the monoesters and monoamides, i.e. the compounds of the formula (V) where M⁺ is particularly H⁺ or NH₄⁺, it being possible for one or more H to be replaced by C₁-C₄-alkyl radicals in NH₄⁺.

Of the last-mentioned monoesters and monoamides, preference is given in turn to those in which one of the two radicals L⁵ and L⁶ is selected from the group consisting of 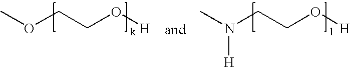
and/or is M⁺H⁺ or NH₄⁺, it being possible for one or more H to be replaced by C₁-C₄-alkyl radicals in NH₄⁺. Of the last-mentioned compounds, particular preference is given to those in which -L⁵ is —O⁻M⁺, especially with M⁺=H⁺ or NH₄⁺, it being possible for one or more H to be replaced by C₁-C₄-alkyl radicals in NH₄⁺.
Component B

As solvents B) it is possible to use not only individual solvents but also mixtures of two or more solvents. Suitable solvents/mixtures are those capable of dissolving, dispersing, suspending or emulsifying the chosen compound/s of the formula (I), (II) and/or (V) (component/s A).

The solvents and mixtures in question can be organic solvents or mixtures thereof or water. Examples of organic solvents include hydrocarbons such as toluene, xylene or mixtures as obtained, for example, in the refining of crude oil and available commercially, for example, as petroleum spirit, kerosene, Solvesso® (from ExxonMobil Chemical, headquartered in Houston) or Risella® (from Shell in Hamburg). Ethers such as tetrahydrofuran (THF) or polyethers such as polyethylene glycol, ether alcohols such as butyl glycol, ether glycol acetates such as butyl glycol acetate, ketones such as acetone, and alcohols such as methanol, ethanol or propanol.

Preferred formulations are those comprising a predominantly aqueous solvent mixture. Such mixtures are understood to be those containing at least 50% by weight, preferably at least 65% by weight, and particularly preferably at least 80% by weight water. Further components in these mixtures are solvents miscible with water. Examples include monoalcohols such as methanol, ethanol or propanol, higher alcohols such as ethylene glycol or polyetherpolyols, and ether alcohols such as butyl glycol or methoxypropanol. Particular preference is given to formulations comprising water as a solvent.

The pH of the aqueous solution is adjusted by the skilled worker, in accordance with the nature of the desired application. Preferred pH values are ≧7, particularly preferably ≧8.5, and are adjusted with ammonia or tertiary amines such as AMP or dimethylethylamine (DMEA).

The amount of the component/s A) dissolved, suspended, dispersed or emulsified in the solvent is determined by the skilled worker in accordance with the nature of the component/s A) and in accordance with the desired application. As a general rule the amount is from 0.1 to 500 g/l, preferably 0.5 to 100 g/l, and more preferably from 1 to 50 g/l without any intention that the invention should be restricted to these amounts. These figures relate to a ready-to-use formulation. It will be appreciated that it is also possible to produce concentrates which are diluted to the desired concentration on site prior to their actual use.

Component C

The formulations of the invention may further comprise additional components. These can be, for example, dispersing assistants, emulsifiers or surface-active compounds. Examples include cationic, anionic, zwitterionic or nonionic surfactants, such as alkyl alkoxylates containing ethylene oxide and/or propylene oxide units, for example.

The formulations may also comprise further corrosion inhibitors, such as butynediol, benzotriazol, aldehydes, amine carboxylates or suitable phosphoric esters, for example.

It is additionally possible to make use, for example, of pigments, examples being conductive pigments such as carbon black, graphite or iron phosphide or anticorrosion pigments such as zinc phosphates or calcium phosphates. These auxiliaries and additives are generally in finely divided form, i.e., their mean particle diameters are in general from 0.005 to 5 μm.

In addition it is also possible to use further polymers, provided that no unwanted properties arise. Examples include (meth)acrylates, styrene-(meth)acrylate copolymers or epoxides.

The invention also provides a process for treating metal surfaces, which involves contacting the metal surface with a formulation of the invention. It is possible to use unpretreated metal surfaces. With preference, however, the metal surfaces are cleaned prior to the treatment. Cleaning in this case preferably comprises, inter alia, degreasing of the metal surface. Suitable cleaning and degreasing techniques are known to the skilled worker. It is also possible to use the formulation of the invention in a process step subsequent to pickling or passivating of the metal surface: for example, in a coating step. The formulations of the invention can also be used as cleaning, pickling and polishing formulations, which may comprise the additives known to the skilled worker and may be used in corresponding processes.

The process of the invention may, for example, include the following steps:
V1) if required, cleaning of the metal surface to remove dirt, fats or oils,
V2) if required, washing with water,
V3) if required, pickling, in the presence where appropriate of the formulation of the invention,
V4) if required, washing with water,
V5) treatment of the metal surface with the formulation of the invention,
V6) if required, washing with water, and
V7) if required, aftertreatment, in the presence where appropriate of the formulation of the invention.

Individual steps will be elucidated in detail below.

Steps V2), V4) and V6)

Washing with water takes place between the steps of the process in order to avoid contamination of the solution used for the next step in each case with the previous solution. It is, however, also possible to forgo one, two or all of washing steps V2), V4) and V6).

Step V5)

In the treatment of metal surfaces with the formulation of the invention a metal surface is contacted with said formulation, by spraying, dipping or coating, for example. The operation in question may comprise, for example, rust removal, paint stripping, metal pickling, electropolishing or corrosion protection. The formulations of the invention are employed with preference in processes for corrosion protection.

The process for corrosion protection can in particular be one in which a metallic surface is coated with the formulation of the invention. The solvent present in the formulation of the invention is largely removed, by simple evaporation for example, preferably by means of a drying step, and on the metal surface there remains an impervious film of component/s A) (polymer film) and also of any further components present, said film protecting the metal surface. The polymer film may of course still contain residues of solvents.

The thickness of such polymer films on metallic surfaces is chosen by the skilled worker in accordance with the desired properties. Generally speaking, however, even surprisingly thin layers are sufficient to achieve the desired corrosion protection effects.

Step V5) may also be a passivation, in particular a phosphating—in accordance with methods known to the skilled worker.

In one preferred embodiment the formulation of the invention comprises one or more elements selected from the group consisting of Ce, Ti, Zr, Hf, V, Fe, Co, Ni, Zn, Zr, Ca, Mn, Cr, Mo, W, Si and B. Preference is given to Cr(III) salts, chromates, molybdates and tungstates and also to flurometallates of Ti(IV), Zr(IV), Hf(IV) and of Si(IV) in acidic formulation.

Subsequent to the application of the first protective film (steps V1) to V7)) the metal surface can be provided with further coatings, examples being paint systems or other coating systems. The coatings are applied in accordance with techniques known to the skilled worker.

Corrosion protection coats applied with the formulation of the invention exhibit very good adhesion to metallic surfaces and with subsequent enhancement coats and im part durable corrosion protection. Moreover, they are stable to weathering and leaching. The metal surfaces thus coated are likewise provided by the present invention.

A further aspect of the invention relates to the use of the novel compounds of the formulae (I), (II) and (V) for treating metals. In this case the novel compounds of the formulae (I), (II) and (V) can be used as they are without solvent. For example, after gentle heating where appropriate, they can be sprayed or poured onto a metallic surface.

The examples which follow illustrate the invention.

### EXAMPLES

### Example 1

### Preparation of the Compounds of the Formula (I)

The composition of the compounds prepared is shown in table 1.

The polyisobutylene used was Glissopal® from BASF AG, Ludwigshafen, having a number average molecular weight Mₙ of from 550 to 1 000, a proportion of vinylidene groups of >70 mol %, a polydispersity M_{w}/Mₙ from 1.1 to 1.4 and a polymer skeleton structure having more than 85% by weight of isobutylene units. This polyisobutylene served as a starting material for the synthesis of succinic anhydride substituted by a polyisobutylenyl group (PIBSA; =polyisobutylene succinic anhydride).

The solvents used were Mihagol, a mixture of C₁₀-C₁₂-paraffins, from Wintershall AG with head office in Kassel, or Solvesso® 150, a mixture of aromatic hydrocarbons from ExxonMobil Chemical with head office in Houston.

The ion exchanger used was that commercially available under the name Ambossol® from Clariant GmbH-Sulzbach.

The maleation of the polyisobutylenes to give the corresponding succinic anhydrides was carried out by methods known per se and is described, for example, in DE-A 195 19 042, DE-A 43 19 671 and DE-A 43 19 672.

The compounds obtained were characterized by means of the acid number, the OH number, the number average molecular weight Mₙ, which was determined using gel permeation chromatography, and the polydispersity M_{w}/Mₙ. M_{w} was likewise determined using gel permeation chromatography. The OH number was determined with a solvent correction, i.e. the OH number of the compounds in the respective solvent was measured and then extrapolated to the pure substance.

TABLE 1
Parameters for the preparation of the compounds of the formula (I)
Cmpd = Compound

| | | | Hydrolysis | | |
|---|---|---|---|---|---|
| | Glissopal ® | | number of | | Amount of ethylene |
| Compound | Mₙ | M_{w}/Mₙ | PIBSA | Polar reactant | oxide [mol/kg] |
| A | 550 | 1.23 | 148 | (HO—CH₂₃ CNH₂ | 7 (Cmpd A1) |
| | | | | | or 11 (Cmpd A2) |
| B | 1 000 | 1.31 | 97 | (HO—CH₂₃ CNH₂ | 6 (Cmpd B1) or 10 |
| | | | | | (Cmpd B2) |
| C | 550 | 1.23 | 148 | (HO—CH₂—CH₂—)₂NH | 8 |
| D | 750 | 1.34 | 120 | D-sorbitol | 8 (Cmpd D1) or 12 |
| | | | | | (Cmpd D2) |
| E | 1 000 | 1.31 | 97 | pentaerythritol | 10 |

TABLE 2
Characterization of the compounds of the formula (I)

| Compound | Mₙ | M_{w}/Mₙ | OH number | Acid number |
|---|---|---|---|---|
| A1 | 970 | 1.31 | 195 | 0.7 |
| A2 | 1 120 | 1.34 | 173 | 0.9 |
| B1 | 1 500 | 1.45 | 131 | 1.0 |
| B2 | 1 730 | 1.47 | 110 | 0.7 |
| C | 1 010 | 1.43 | 149 | not determined |
| D1 | 1 400 | 1.56 | 204 | 32.0 |
| D2 | 1 580 | 1.60 | 175 | 28.0 |
| E | 2 050 | 1.63 | 106 | 19.4 |

Preparation of Compound A:

A 2 l four-necked flask having a stirrer, distillation bridge and thermocouple is filled with 525 g of PIBSA 550, 650 g of Mihagol and 175 g of trihydroxymethylaminomethane (TRIS). The mixture is heated stepwise to 130° C. or 170° C. Water liberated is removed by means of a nitrogen stream; the duration of the reaction is 3 hours. (The OH number was determined as 250 after correction for the solvent.)

A 50% strength by weight solution in Mihagol is prepared. Reaction with ethylene oxide and potassium tert-butylate as catalyst is then effected according to a standard process. Two degrees of ethoxylation with 7 mol and 11 mol of ethylene oxide/kg of solution are established (products A1 and A2). The orange-brown product is stirred for 60 minutes at 60° C. with addition of 5 g of water and 10 g of the ion exchanger Ambossol® per 100 g of product solution and is then filtered.

In each case an equilibrium mixture of the monoamides (IVa) and (IVb) and imide (IVc) is obtained. PIB is a polyisobutylene group. x, y and z are integers whose sum is 7 or 11. 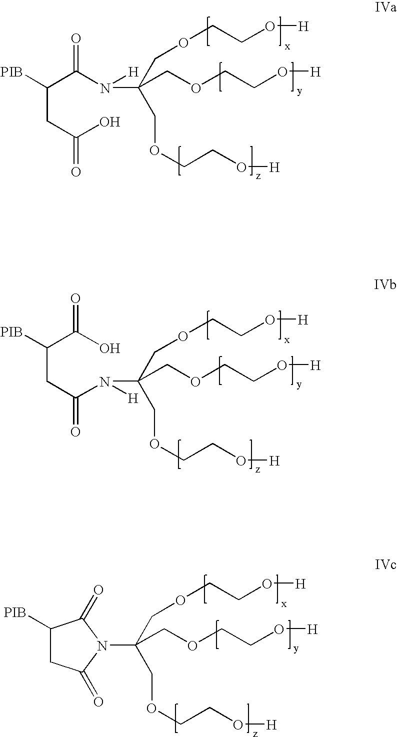
Preparation of Compound B:

A 2 l four-necked flask having a stirrer, distillation bridge and thermocouple is filled with 690 g of PIBSA 1000, 650 g of Solvesso® 150 and 150 g of trihydroxymethylaminomethane (TRIS). The mixture is heated stepwise to 130° C. or 170° C. Water liberated is removed by means of a nitrogen stream; the duration of the reaction is 3 hours. (The OH number was determined as 158 after correction for the solvent.)

A 50% strength by weight solution in Solvesso® 150 is prepared. Reaction with ethylene oxide and potassium tert-butylate as catalyst is then effected according to a standard process. Two degrees of ethoxylation with 6 mol and 10 mol of ethylene oxide/kg of solution are established (products B1 and B2). The working-up is effected analogously to give compound A.

Preparation of Compound C:

A 1 l four-necked flask having a stirrer, dropping funnel and thermocouple is filled with 250 g of PIBSA 550 and heated to 90° C. 67 g of diethanolamine are metered in via the dropping funnel in the course of 5 minutes. The mixture is heated stepwise to 130° C. or 170° C. After 2 hours at 170° C., the brown reaction product is diluted with Solvesso® 150 to a 50% strength by weight solution and filtered at 100° C. The reaction is then effected with 8 mol of ethylene oxide/kg of solution and potassium tert-butylate as catalyst according to a standard process. The working-up is effected analogously to give compound A.

Preparation of Compound D:

A 1 l four-necked flask having a stirrer, distillation bridge and thermocouple is filled with 310 g of PIBSA 750 and 60 g of D-sorbitol. The mixture is heated stepwise to 160° C. or 220° C. Water liberated is removed by means of a nitrogen stream; after 3 hours at 220° C., dilution is effected with 200 g of Solvesso® 150 to a 50% strength by weight solution and filtration is effected at elevated temperatures. The yellow product solution is reacted with 8 or 12 mol of ethylene oxide/kg of solution and potassium tert-butylate as catalyst to give the compounds D1 and D2. The working-up is effected analogously to give compound A.

Preparation of Compound E:

A 1 l four-necked flask having a stirrer, distillation bridge and thermocouple is filled with 550 g of PIBSA 1000 and 65 g of pentaerythritol. The mixture is heated stepwise to 180° C. or 245° C. Water liberated is removed by means of a nitrogen stream; after 3 hours at 245° C., dilution is effected with Solvesso® 150 to a 50% strength by weight solution and filtration is effected at elevated temperatures. Reaction is then carried out with 10 mol of ethylene oxide/kg of solution and potassium tert-butylate as catalyst according to a standard process. The working-up is effected analogously to give compound A.

### Example 2

### Use Examples of the Compounds of the Formula (I)

Foam Suppression (Beer-Glue Test):

With reference to the dirt occurring during bottle washing, an alkaline mixture of beer, label adhesive and paper paste is prepared. 750 ml of this test solution are mixed with 0.2 g/l of a compound of the formula (I) and continuously circulated by pumping at 900 ml/min. The foam height is read over a temperature range from 7° C. to 80° C. Without addition of surfactant, the foam height is 2.5 at 20° C., 5.0 at 40° C. and 8.0 at 60° C. In the comparative example, Emulan HE 50, an alcohol ethoxylate from BASF AG, Ludwigshafen, was used.

With compound A2, excellent foam suppression is achieved in the temperature range up to 50° C., while D and E showed good to very good foam suppression in the entire temperature range.

TABLE 3
Foam height using surfactant solutions at different temperatures

| | Foam height | Foam height | | |
|---|---|---|---|---|
| | Compound | Compound | Foam height | Foam height |
| Temperature | A2 | D | Compound E | Emulan HE 50 |
| 7° C. | 0 | 2.5 | 3.5 | 5.5 |
| 10° C. | 0.3 | 3.0 | 3.5 | 5.3 |
| 15° C. | 0.3 | 2.5 | 3.5 | 5.0 |
| 20° C. | 1.2 | 2.4 | 3.5 | 4.0 |
| 25° C. | 1.6 | 2.7 | 3.5 | 3.0 |
| 30° C. | 1.9 | 2.5 | 3.5 | 3.5 |
| 35° C. | 2.6 | 2.4 | 2.5 | 3.0 |
| 40° C. | 3.0 | 2.3 | 2.5 | 3.0 |
| 45° C. | 3.9 | 2.7 | 2.5 | 3.0 |
| 50° C. | 4.4 | 2.9 | 2.3 | 3.5 |
| 55° C. | 5.0 | 3.2 | 2.3 | 4.0 |
| 60° C. | 4.8 | 3.2 | 2.5 | 4.0 |
| 70° C. | 5.1 | 2.9 | 2.6 | 3.0 |
| 80° C. | 5.0 | 3.8 | 3.0 | 2.5 |

Imparting Water Repellency to Metal Surfaces:

VA stainless steel test sheets are first cleaned in dichloromethane. An aqueous 0.01% strength by weight solution of a compound of the formula (I), if required with addition of a neutral solubilizer, e.g. Lutensol FA 10K, a fatty amine ethoxylate from BASF AG, Ludwigshafen, is then prepared and the metal sheets are stored in this solution for 1-2 days. After removal and washing with demineralized water, the metal sheets are dried. A drop of water is carefully placed on top using a syringe. The contact angle is measured with the aid of a goniometer (type G2) from Krüss with head office in Hamburg and is compared with that of the untreated sample. The larger the contact angle, the smaller is the contact area between water drop and metal surface.

The sample with the use of compound D exhibits a contact angle of 90°; the sample with the use of compound A1 exhibits a contact angle of 97°. In contrast, a value of about 700 is found in the case of an untreated, cleaned metal sheet. Accordingly, metal surfaces are rendered water repellent by treatment with solutions containing compounds of the formula (I).

Solubilization of Oils:

A compound of the formula (I) is mixed with a mineral oil (e.g. Mihagol) in the ratio 1:1 w/w (% by weight). If this mixture is added dropwise to water while stirring, a clear to opaque solution is obtained. With the compounds A1, A2 and B2, a clear solution is obtained in this test. If this test is carried out using the mineral oil without addition of a compound of the formula (I), the oil drops float on the liquid surface. This means that solubilization of oils in water takes place only as a result of addition of the compounds of the formula (I).

Lubricity-Improving Property:

In order to test the lubricating effect in cooling lubricants, the frictional wear test is carried out with the aid of the Reichert frictional wear balance. In the case of an applied weight of 1.5 kg (corresponding to a total load of 30 kg), a running distance of 110 m is covered. The speed is 111 m/min. An aqueous 1% strength by weight solution of compound E, which contains 3% by weight of Lutensol FA 10K, a fatty amine ethoxylate from BASF AG, Ludwigshafen, leads to a lubricating effect after a running distance of 22 m and prevents further abrasion of material. The temperature difference is 11.5 Kelvin. With compound C, the abovementioned effect is observed after only 18 m.

In comparison, a product used as standard in cooling lubricants, Pluronic® PE 6100, a polyethylene glycol/polypropylene glycol copolymer from BASF AG, Ludwigshafen, leads to greater wear at a comparable concentration: lubricating effect occurs only from 29 m, the temperature difference being 20.3 Kelvin.

Determination of the Critical Micelle Formation Concentrations (CMC Values) and Surface Tension:

The CMC was determined according to DIN 53914. The CMC gives the concentration of surfactants in aqueous solution at which micelle formation begins or at which no further reduction in the surface tension takes place as a result of increasing the concentration.

An aqueous solution of the compound of the formula (I) to be investigated is prepared and is introduced into the crystallizing dish which has been previously carefully washed and burnt out with ethanol. Before the measurement, the platinum/iridium ring is washed in distilled water and ethanol, thoroughly baked, and suspended in the apparatus of the tensiometer. The measurement is started. After the end of the measurement, the value of the result obtained, corrected according to Harkins-Jordan, is read as the surface tension of the product to be investigated, in mN/m. At least 5 measurements are required; the standard deviation is specified: 0.3 mN/m.

The surface tension values measured at the various concentration levels are plotted against the concentration values. The critical micelle concentration is obtained from the point of inflection of the surface tension-concentration curve by extrapolation.

TABLE 4
Surface tension and CMC values of solutions
of the compounds of the formula (I)

| Compound | CMC [g/l] | Surface tension [mN/m] |
|---|---|---|
| A1 | 0.47 | 39.1 |
| A2 | 0.39 | 28.9 |
| B2 | 0.55 | 41.0 |
| C | 0.58 | 43.9 |
| D | 0.67 | 41.8 |
| E | 0.82 | — |

### Example 3

### Preparation of the Compounds of the Formula (II)/(V)

Preparation of Compound F:

A 2 l four-necked flask having a stirrer, dropping funnel and thermocouple is filled with 300 g of polyethylene glycol (Mn=300; Pluriol E®300 from BASF AG, Ludwigshafen) and degassed at 90° C. for 30 minutes under reduced pressure. It is cooled to 80° C., and 375 g of PIBSA 550 (hydrolysis number=147; M_{w}/Mₙ=1.23) are metered in under an N₂ atmosphere. The mixture is heated stepwise to 140° C. or 250° C. After 5 hours at 250° C., the orange-brown product is filtered at from 80 to 110° C. The OH number of the product was determined as 115; an intense band at 1 736 cm⁻¹ (ester) is observable in the IR.

The preparation of compound G from pluriol E®600 BASF AG, Ludwigshafen, and PIBSA550, and the preparation of compound H from pluriol E®600 from BASF AG Ludwigshafen, and PIBSA 1000 is accomplished in analogy to the preparation of compound F.

### Example 4

### Use Examples of the Compounds of the Formula (II)/(V)

Corrosion Inhibition Property:

The corrosion inhibition properties of aqueous dispersions comprising novel compounds of the formula (II)/(V) were investigated.

In this case the compounds G and H respectively were each dissolved in a solvent mixture composed of equal volume fractions of butyl glycol, Solvenon® PP and white spirit to give a 20% strength by weight solution. Solvenon® PP is a propoxypropanol from BASF AG, Ludwigshafen. The white spirit from ExxonMobil, headquartered in Houston, is an aromatic hydrocarbon mixture and has a boiling range of from 180 to 210° C.

The solvents stated served simultaneously as film-forming auxiliaries, in order to ensure formation of a film from the dispersions. The concentrations at which compounds G and H were used were 0.1% and 0.5% by weight respectively, each based on the total weight of the dispersion. Dispersion 1 is based on Acronal® S 760, dispersion 2 on Acronal® LR 8977. In order to accelerate the tests no film-forming auxiliaries were added to the dispersions. The composition of the dispersions is given in table 5. The dispersions 1 and 2 indicated in table 5 are dispersions as are employed—absent the compounds of the invention—in heavy corrosion protection in accordance with the prior art.

Acronal® S 760 and Acronal® LR 8977 are styrene-acrylate dispersions from BASF AG, Ludwigshafen. Byk® 022 is a silicone defoamer from Byk-Chemie, Wesel. Surfynol® 104 is a butynediol derivative from Air Products, Manchester, UK, and serves as wetting agent. Lutensit® A-EP is a phosphate ester from BASF AG, Ludwigshafen, serving as wetting agent. Bayferrox® 130 M is a red iron oxide pigment from Bayer AG, Leverkusen. Talcum 20 M 2 is a magnesium silicate hydrate from Talc de Luzenac, Luzenac-Sur-Ariege, France. Heucophos® ZPZ is a zinc phosphate from Heubach GmbH, Langelsheim. Lithopone® L is a filler comprising ZnS and barium sulfate from Sachtleben, Duisburg, with a weight fraction of 30% by weight ZnS. Collacral® PU 85 is a urethane associative thickener from BASF AG, Ludwigshafen. The mineral spirit used has a boiling point of from 180 to 210° C. and the water used has been fully demineralized.

The corrosion inhibitor L1 from Erbslöh, Krefeld, contains nitrite and was diluted with water in a volume ratio of 1 to 1. This corrosion inhibitor has no effect on the long-term activity toward corrosive media but serves merely to prevent rusting of the coating in the wet state immediately following the application of the dispersion.

TABLE 5
Composition of the Dispersions

| | Composition of | Composition of |
|---|---|---|
| | Dispersion 1 | Dispersion 2 |
| Individual Components | (amounts in g) | (amounts in g) |
| Acronal ® S 760 | 559.8 | — |
| Acronal ® LR 8977 | — | 416.6 |
| Byk ® 022 | 4.1 | 3.8 |
| Surfynol ® 104 | — | 3.7 |
| Mineral spirit | 7.2 | 7.5 |
| Solvenon ® PP | 7.2 | 7.5 |
| Butyl glycol | 13.2 | 11.0 |
| Demineralized water | 58.6 | 69.3 |
| Lutensit ® A-EP | 0.6 | 1.0 |
| Ammonia | 11.0 | 29.8 |
| Bayferrox ® 130 M | 85.0 | 113.3 |
| Talcum 20 M 2 | 36.0 | 47.1 |
| Heucophos ® ZPZ | 82.1 | 109.8 |
| Lithopone ® L | 127.8 | 170.4 |
| Corrosion inhibitor L1 | 3.7 | 5.4 |
| Collacral ® PU 85 | 3.7 | 3.7 |

Adhesion of Coatings Produced on Metallic Surfaces With the Addition of Novel Compounds of the Formula (II)/(V)

Dispersions 1 and 2 were each admixed with 0.1% or 0.5% by weight of compound G or H, based on the total weight of the dispersion. The paints thus obtained were applied using a 300 μm slotted doctor blade to 1405 steel and dried at room temperature. This gave the films a thickness of 80 to 90 μm. The adhesion was tested in accordance with EN ISO 2409.

An investigation was conducted as to whether there is a time-dependent change in the adhesion of the paints to the steel. Consequently, the adhesion was determined at different sites over a prolonged period of time. In order to ensure that water was no longer present in the coating the first test was not conducted until after 4 days. The subsequent tests took place at intervals of one week.

The results are given in table 6 below. Gt denotes cross-cut or measurement. A low value for Gt denotes effective adhesion, a high value poor adhesion.

TABLE 6
Adhesion to EN ISO 2409 using dispersion 1

| | Gt after | Gt after | Gt after | Gt after |
|---|---|---|---|---|
| Dispersion 1 | 4 days | 1 week | 2 weeks | 3 weeks |
| — | 1 to 2 | 0 to 1 | 0 to 1 | 0 to 2 |
| +0.1% by weight | 0 | 0 | 0 | 0 to 1 |
| of compound G | | | | |
| +0.5% by weight | 0 to 1 | 0 to 1 | 0 to 1 | 0 to 1 |
| of compound G | | | | |
| +0.1% by weight | 1 to 2 | 0 to 1 | 0 | 0 to 1 |
| of compound H | | | | |
| +0.5% by weight | 1 to 2 | 0 to 1 | 0 to 1 | 0 to 1 |
| of compound H | | | | |

TABLE 7
Adhesion to EN ISO 2409 using dispersion 2

| | Gt after | Gt after | Gt after | Gt after |
|---|---|---|---|---|
| Dispersion 2 | 4 days | 1 week | 2 weeks | 3 weeks |
| — | 1 to 2 | 1 to 2 | 1 to 2 | 1 to 2 |
| +0.1% by weight | 1 | 1 to 2 | 0 to 1 | 0 to 1 |
| of compound G | | | | |
| +0.5% by weight | 0 to 2 | 1 to 2 | 0 to 1 | 1 to 2 |
| of compound G | | | | |
| +0.1% by weight | 1 | 1 to 2 | 0 to 1 | 0 to 1 |
| of compound H | | | | |
| +0.5% by weight | 1 to 2 | 1 | 0 to 1 | 1 to 2 |
| of compound H | | | | |

The fluctuations in the values for Gt as a function of time are a result of the diffusion of water out of and into the films. The films produced using the compounds of the invention showed an equal or better adhesion in long-term action than the films produced with conventional paints.

Effect of the Compounds of the Formula (II) on Early Water Resistance

Dispersions 2—with and without compounds of the formula (II)/(V)—were applied to sandblasted metal panels. Films with a thickness of 100 to 125 μm were obtained. After 2 h drying at room temperature the panels were placed ¾ in water for 24 h. Subsequently the 20 degree of blistering was assessed in accordance with DIN ISO 4628-2. A high blister count or blister size means that a large amount of water has penetrated the coating, resulting in paint damage and/or corrosion.

TABLE 8
Early water resistance in a dispersion 2

| Dispersion 2 | Blister count m | Blister size g |
|---|---|---|
| — | 3 to 4 | 2 to 4 |
| +0.1% by weight of | 0 | 0 |
| compound G | | |
| +0.5% by weight of | 3 | 2 to 3 |
| compound G | | |
| +0.1% by weight of | 2 to 3 | 2 to 3 |
| compound H | | |
| +0.5% by weight of | 3 | 2 to 3 |
| compound H | | |

Here again it was found that the early water resistance could be improved through use of the compounds of the invention.

Effect of the Compounds of the Formula (II)/(V) on the Corrosion Protection Properties—Salt Spray Test to DIN 50 021

Dispersions 1 were applied to 1405 steel and dried at room temperature for one week and at 50° C. for one day. After the drying operation the metal panels were placed in a suitable testing apparatus for testing to ISO 7253 and were provisionally assessed at different times in order to observe the progress of corrosion and to find the correct moment for the end of the test. Final assessment was made after 240 h.

The results are given in table 9 below.

TABLE 9
Assessment of dispersions 1 in accordance with DIN ISO 4628-2
(blistering) and EN ISO 2409 (adhesion) after the salt spray test

| | Cut | | | | | | | |
|---|---|---|---|---|---|---|---|---|
| | Extent of | Blisters | | | | Surface | | |
| | sub-film | (DIN ISO | | | | | Cross-cut | Film |
| | migration | 4628-2) | | Delamination | Sub-film | | ISO 2409 (after | thickness |
| Dispersion 1 | [mm] | mm | m/g | [mm] | rusting [mm] | Blisters m/g | 1 h/24 h) | [μm] |
| — | 8 | 2 to 8 | m5/g2-4 | 1 to 6 | 1 to 6 | 3%, m5/g3 | 1/0 to 2 | 60-80 |
| +0.1% by weight | 6 | 2 to 5 | m3/g2 | 2 to 4 | 2 to 4 | 2%, m3/g2-3 | 1/0 | 60-80 |
| of compound G | | | | | | | | |
| +0.5% by weight | 8 | 1 to 7 | m3/g2-4 | 2 to 4 | 2 to 4 | 2%, m3/g2 | 1/1 | 60-80 |
| of compound G | | | | | | | | |
| +0.1% by weight | 6 | 1 to 7 | m3/g2-4 | 1 to 4 | 1 to 4 | 1 pore | 1/0 | 60-80 |
| of compound H | | | | | | | | |
| +0.5% by weight | 5 to 8 | 1 to 3 | m3/g2 | 1 to 4 | 1 to 4 | 5%, m5/g2-3 | 1/1 | 60-80 |
| of compound H | | | | | | | | |

Here again, comparing the data for films produced with conventional dispersions and for films produced with dispersions comprising compounds of the invention, it is found that the compounds of the invention are able to improve the corrosion protection, particularly in long-term action.

1-23. (canceled)

24. A compound of the formula (I) 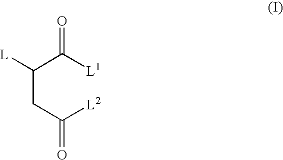
where -L is a polyisobutylenyl group having a number average molecular weight Mₙ of from 300 to 10 000,
-L¹ and -L², independently of one another, are -A¹, -A² or —O-M⁺, one of the two being -A¹, or
-L¹ and -L² together are 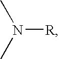
-A¹ is 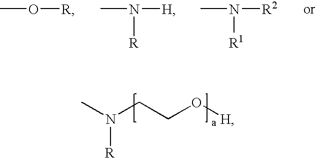
-A² is 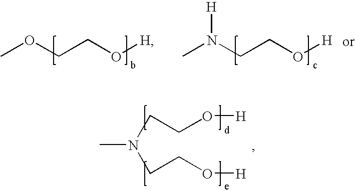
M⁺ is H⁺, an alkali metal cation, 0.5 alkaline earth metal cation, other metal cations or NH₄⁺, it being possible for one or more H to be replaced by C₁-C₄-alkyl radicals in NH₄⁺,
R is a linear or branched saturated C₃-C₁₂-hydrocarbon radical or a cyclic or heterocyclic saturated C₄-C₁₂-hydrocarbon radical
which carries at least two building blocks selected from the group 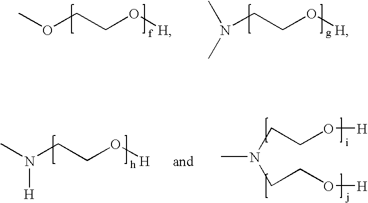
and
if required, one or more —OH, —NH₂, —NH₃⁺ and/or —C(H)O and/or comprises one or more nonneighboring —O— and/or —N(H)—,
it being possible for one or more H to be replaced by C₁-C₄-alkyl radicals in —N(H)—, —NH₂ or —NH₃⁺,
R¹ and R², independently of one another, are a linear saturated C₂-C₁₂-hydrocarbon radical or a branched saturated C₃-C₁₂-hydrocarbon radical,
the two hydrocarbon radicals together carrying at least two building blocks selected from the group 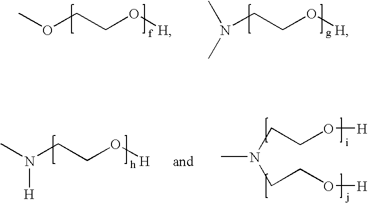
and, if required, one or more —OH, —NH₂, —NH₃⁺ and/or —C(H)O and/or comprising one or more nonneighboring —O— and/or —N(H)—,
and it being possible for one or more H to be replaced by C₁-C₄-alkyl radicals in —N(H), —NH₂ or —NH₃⁺, and
a, b, c, d, e, f, g, h, i and j in the individual building blocks are identical or different and are integers from 1 to 50.

25. A compound as claimed in claim 24, wherein the proportion of A¹+A² in the compound of the formula (I) is at least 15% by weight.

26. A compound as claimed in claim 24, wherein the proportion of A¹+A² in the compound of the formula (I) is at least 30% by weight.

27. A compound as claimed in claim 24, wherein the proportion of A¹+A² in the compound of the formula (I) is from 40 to 60% by weight.

28. A compound as claimed in claim 24, wherein -L is a polyisobutylenyl group having a number average molecular weight Mₙ of from 300 to 1200, or is a polyisobutylenyl group having a number average molecular weight of from 2 000 to 10 000.

29. A compound as claimed in claim 24, wherein -L is a polyisobutylenyl group having a number average molecular weight Mₙ of from 300 to 1000.

30. A compound as claimed in claim 24, wherein -L is a polyisobutylenyl group having a number average molecular weight Mₙ of from 2000 to 5500.

31. A compound as claimed in claim 24, wherein -L is a polyisobutylenyl group which has a polydispersity of ≦3.0.

32. A compound as claimed in claim 24, wherein -L is a polyisobutylenyl group which has a polydispersity from 1.1 to 2.5.

33. A compound as claimed in claim 24, wherein -L is a polyisobutylenyl group which has a polydispersity from 1.1 to 2.0.

34. A compound as claimed in claim 24, wherein -L is a polyisobutylenyl group which is composed of at least 80% by weight of isobutylene units.

35. A compound as claimed in claim 24,
wherein one of the two substituents -L¹ and -L² is —O-M⁺ and
the other is —O—R, —N(H)R or —NR¹R² and
R is a linear or branched saturated C₄-C₁₂-hydrocarbon radical which carries from 3 to 10 substituents selected from the group consisting of —O[CH₂—CH₂—O—]_{f}H and
—N(H)[CH₂—CH₂—O—]ₕH and, if required,
one or more —OH, —NH₂ and/or —C(H)O and/or
comprises one or more —O— and/or —N(H)—,
f and h in the individual substituents being identical or different and being integers from 1 to 10, or
R¹ and R², independently of one another, are two linear or branched saturated hydrocarbon radicals having a total of 4 to 12 carbon atoms, which together carry a total of from 3 to 10 substituents selected from the group consisting of
—O[CH₂—CH₂—O—]_{f}H and —N(H)[CH₂—CH₂—O—]ₕH and, if required,
one or more —OH, —NH₂ and/or —C(H)O and/or
comprise one or more —O— and/or —N(H)—,
f and h in the individual substituents being identical or different and being integers from 1 to 10.

36. A compound as claimed in claim 24, wherein
one of the two substituents -L¹ and -L² is —O-M⁺ and
the other is —O—R or —N(H)R and
R is a linear or branched saturated C₄-C₁₂-hydrocarbon radical which carries from 3 to 10 —O[CH₂—CH₂—O—]_{f}H substituents and,
if required, one or more —OH and/or —C(H)O,
f in the individual —O[CH₂—CH₂—O—]_{f}H substituents being identical or different and being an integer from 1 to 10.

37. A compound as claimed in claim 24, wherein
one of the two substituents -L¹ and -L² is —O-M⁺ and
the other is —O—R or —N(H)R and
R is a linear or branched saturated C₄-C₁₂-hydrocarbon radical which carries from 3 to 6 —O[CH₂—CH₂—O—]_{f}H substituents and,
if required, one or more —OH and/or —C(H)O,
f in the individual —O[CH₂—CH₂—O—]_{f}H substituents being identical or different and being an integer from 1 to 10.

38. A compound as claimed in claim 24, wherein
-L¹ and -L² together are 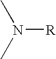
and
R is a linear or branched saturated C₄-C₁₂-hydrocarbon radical which carries from 3 to 6 —O[CH₂—CH₂—O—]_{f}H substituents and,
if required, one or more —OH and/or —C(H)O,
f in the individual —O[CH₂—CH₂O—]_{f}H substituents being identical or different and being an integer from 1 to 10.

39. A compound as claimed in claim 24, wherein
-L¹ and -L² together are 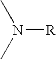
and
R is a linear or branched saturated C₄-C₁₂-hydrocarbon radical which carries from 3 to 6 —O[CH₂—CH₂—O—]_{f}H substituents and,
if required, one or more —OH and/or —C(H)O,
f in the individual —O[CH₂—CH₂—O—]_{f}H substituents being identical or different and being an integer from 1 to 10.

40. A compound as claimed in claim 24, according to the formula (II) 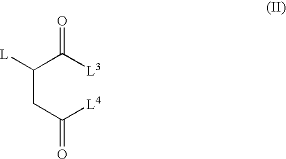
where -L is a polyisobutylenyl group having a number average molecular weight Mₙ of from 300 to 10 000,
-L³ and -L⁴, independently of one another, are 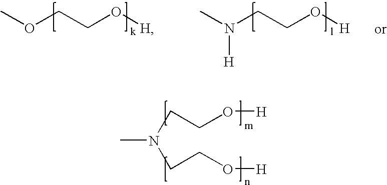
and
k, l and the sum of m and n in the individual units are identical or different and are integers from 4 to 50.

41. A compound as claimed in claim 24, according to the formula (V) 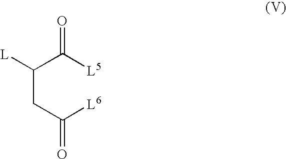
where -L is a polyisobutylenyl group having a number average molecular weight Mₙ of from 300 to 10000,
-L⁵ and -L⁶ independently of one another, are selected from the group consisting of —O-M⁺, 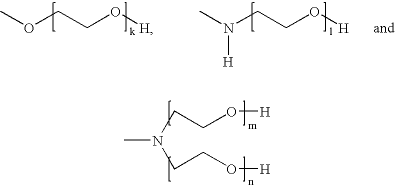
one of the two radicals -L⁵ and -L⁶ being —O-M⁺,
and M⁺ is H⁺, an alkali metal cation, 0.5 alkaline earth metal cation, further metal cations or NH₄⁺, it being possible for one or more H to be replaced by C₁-C₄-alkyl radicals in NH₄⁺, and
k, l and the sum of m and n in the individual units are identical or different and are integers from 4 to 50.

42. A process for the preparation of compounds of the formula (I) as defined in claim 24, which comprises the following process steps:
a) reaction of polyisobutylene with fumaryl dichloride, fumaric acid, maleyl dichloride, maleic acid or maleic anhydride to give compounds of the formula (IIIa), (IIIb) or (IIIc), 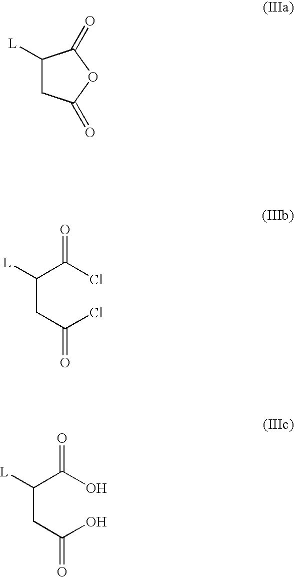
b) reaction of the compounds of the formula (IIIa), (IIIb) or (IIIc) which are obtained by step a) with a polar reactant selected from the group consisting of R*OH, R*NH₂ and R¹*R²*NH and
c) reaction of the reaction products obtained by step b) with ethylene oxide, and
d) if required, hydrolysis of —COCl present to —CO₂H, and
e) if required, conversion of —CO₂H and/or —COCl present with NH₃, amines or alkali metal or alkaline earth metal salts or metal salts into the corresponding salts,
where R* is a linear or branched saturated C₃-C12-hydrocarbon radical or is a cyclic or heterocyclic saturated C₄-C₁₂-hydrocarbon radical which comprises at least two building blocks selected from the group consisting of —OH, —N(H)— and —NH₂ and,
if required, carries one or more —NH₃⁺ and/or —C(H)O and/or comprises one or more —O—,
R¹* and R²*, independently of one another, are a linear saturated C₂-C₁₂-hydrocarbon radical or are a branched saturated C₃-C₁₂-hydrocarbon radical, the two hydrocarbon radicals together comprising at least two building blocks selected from the group consisting of —OH, —N(H)— and —NH₂ and,
if required, carrying one or more —NH₃⁺ and/or —C(H)O and/or comprising one or more —O—,
although it being possible to replace one or more H in the —N(H)—, —NH₂ and/or —NH₃⁺ by C₁-C₄-alkyl radicals, it still being necessary for at least two building blocks selected from the group consisting of —OH, —N(H)— and —NH₂ to be present as such.

43. A process for the preparation of the compounds of the formula (II) 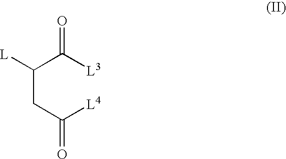
where -L of formula (II) is a polyisobutylenyl group having a number average molecular weight Mₙ of from 300 to 10000,
-L³ and -L⁴, independently of one another, are 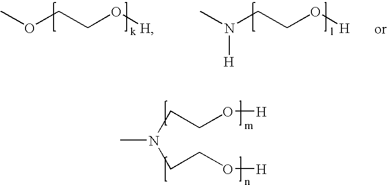
and
k, l and the sum of m and n in the individual units are identical or different and are integers from 4 to 50
or compounds of the formula (V) 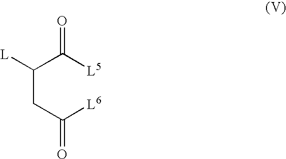
where -L of formula (V) is a polyisobutylenyl group having a number average molecular weight Mₙ of from 300 to 10000,
-L⁵ and -L⁶ independently of one another, are selected from the group consisting of —O-M⁺, 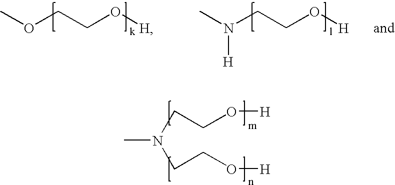
one of the two radicals -L⁵ and -L⁶ being —O-M⁺,
and M⁺ is H⁺, an alkali metal cation, 0.5 alkaline earth metal cation, further metal cations or NH₄⁺, it being possible for one or more H to be replaced by C₁-C₄-alkyl radicals in NH₄⁺, and
k, l and the sum of m and n in the individual units are identical or different and are integers from 4 to 50
said process comprising the following steps:
α) reaction of polyisobutylene with fumaryl dichloride, fumaric acid, maleyl dichloride, maleic acid or maleic anhydride to give compounds of the formula (IIIa), (IIIb) or (IIIc), 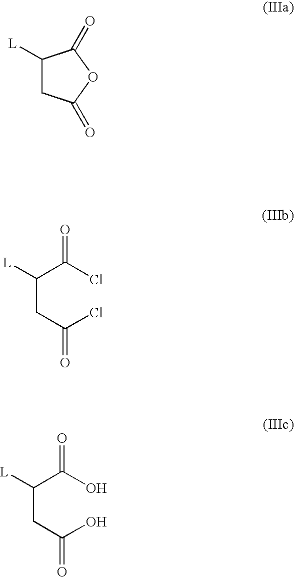
β) if required, reaction of the compounds (IIIa) and (IIIc) with ammonia, ethanolamine or diethanolamine, and
γ) reaction of the compounds obtained by steps α) and β) with ethylene oxide or oligo- or polyethylene glycol,
δ) if required, hydrolysis of —COCl present to —CO₂H,
ε) if required, conversion of —CO₂H and/or —COCl present with NH₃, amines or metal, alkali metal or alkaline earth metal salts into the corresponding salts,
where -L is a polyisobutylenyl group having a number average molecular weight Mₙ of from 300 to 10 000,
-L³ and -L⁴, independently of one another, are 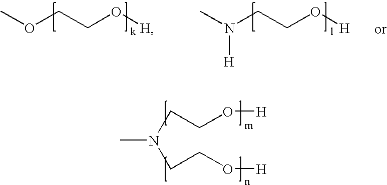
-L⁵ and -L⁶ are selected, independently of one another, from the group consisting of —O-M⁺, 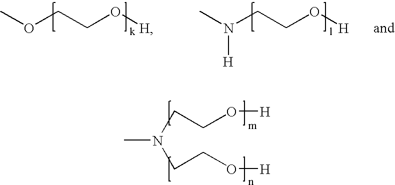
one of the two radicals -L⁵ and -L⁶ being —O-M⁺, and M⁺ being H⁺, an alkali metal cation, 0.5 alkaline earth metal cation, further metal cations or NH₄⁺, it being possible for one or more H to be replaced by C₁-C₄-alkyl radicals in NH₄⁺, and
k, l and the sum of m and n in the individual units are identical or different and are integers from 4 to 50.

44. An oil-in-water emulsion comprising from 60 to 95% by weight of water, from 3 to 35% by weight of oil and from 0.2 to 10% by weight of one or more compounds of the formulae (I) as claimed in claim 24 as an emulsifier.

45. An oil-in-water emulsion comprising from 60 to 95% by weight of water, from 3 to 35% by weight of oil and from 0.2 to 10% by weight of one or more compounds of the formulae (II) as claimed in claim 40 as an emulsifier.

46. An oil-in-water emulsion comprising from 60 to 95% by weight of water, from 3 to 35% by weight of oil and from 0.2 to 10% by weight of one or more compounds of the formulae (V) as claimed in claim 41 as an emulsifier.

47. An emulsion according to claim 44, wherein from 0.5 to 5% by weight of one or more compounds of the formulae (I), (II) and/or (V) are present; wherein formula (II) is as follows: 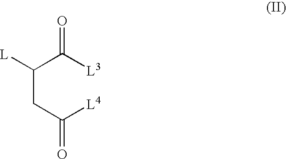
where -L of formula (II) is a polyisobutylenyl group having a number average molecular weight Mₙ of from 300 to 10000,
-L³ and -L⁴, independently of one another, are 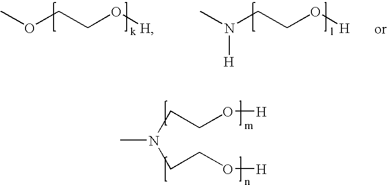
and
k, l and the sum of m and n in the individual units are identical or different and are integers from 4 to 50
and formula (V) is as follows: 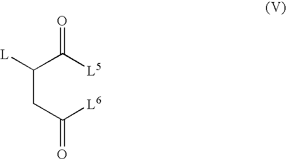
where -L of formula (V) is a polyisobutylenyl group having a number average molecular weight Mₙ of from 300 to 10000,
-L⁵ and -L⁶ independently of one another, are selected from the group consisting of —O-M⁺, 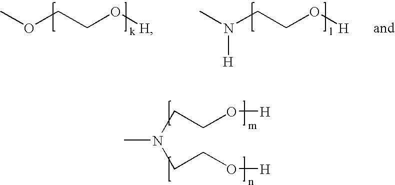
one of the two radicals -L⁵ and -L⁶ being —O-M⁺,
and M⁺ is H⁺, an alkali metal cation, 0.5 alkaline earth metal cation, further metal cations or NH₄⁺, it being possible for one or more H to be replaced by C₁-C₄-alkyl radicals in NH₄⁺, and
k, l and the sum of m and n in the individual units are identical or different and are integers from 4 to 50.

48. An emulsion as claimed in claim 44, wherein, in addition to one or more compounds of the formulae (I) one or more further emulsifiers and/or one or more biocides are present.

49. An emulsion as claimed in claim 44, wherein, in addition to one or more compounds of the formulae (I), one or more further emulsifiers from the group sorbitan monooleate, C₁₃-oxo alcohol ethoxylates and alkylphenol ethoxylates, and/or one or more biocides are present.

50. The method of using of a compound of the formulae (I) as defined in claim 24 as a surfactant in electroplating, as an antifoam and as a solubilizer for oils in detergent and cleaning formulations and for solubilizing fragrances and care oils for cosmetic applications, for imparting water repellency to metal surfaces, in the tanning or washing and degreasing of leather and as a wetting agent for water-based surface coatings, finishes and adhesives.

51. The method as claimed in claim 50, wherein the compound is a compound of formula (II) as defined in claim 40.

52. The method as claimed in claim 50, wherein the compound is a compound of formula (V) as defined in claim 41.

53. A formulation for treating metal surfaces, comprising
A) at least one compound of the formula (I) as defined in claim 24,
B) at least one solvent capable of dissolving, dispersing, suspending or emulsifying component/s A), and
C) if required, further components.

54. A formulation for treating metal surfaces, comprising
A) at least one compound of the formula (II) as defined in claim 40,
B) at least one solvent capable of dissolving, dispersing, suspending or emulsifying component/s A), and
C) if required, further components.

55. A formulation for treating metal surfaces, comprising
A) at least one compound of the formula (V) as defined in claim 41,
B) at least one solvent capable of dissolving, dispersing, suspending or emulsifying component/s A), and
C) if required, further components.

56. A formulation as claimed in claim 53, wherein the solvent B) is water.

57. A process for treating metal surfaces, which comprises contacting the metal surface with a formulation as defined in claim 53.

58. A process as claimed in claim 57, comprising the following steps:
V1) if required, cleaning of the metal surface to remove dirt, fats or oils,
V2) if required, washing with water,
V3) if required, pickling, in the presence where appropriate of the formulation of the invention,
V4) if required, washing with water,
V5) treatment of the metal surface with the formulation of the invention,
V6) if required, washing with water, and
V7) if required, aftertreatment, in the presence where appropriate of the formulation of the invention.

59. A process for corrosion protection, which comprises coating a metallic surface with a formulation as claimed in claim 53.

60. A metallic surface, comprising:
at least one coating with at least one compound as defined in claim 24 and, if required,
further components, obtained by coating with a formulation comprising
A) at least one compound of the formula (I),
B) at least one solvent capable of dissolving, dispersing, suspending or emulsifying component/s A), and
C) if required, further components,
followed by removal of the solvent.

61. The method of using of a compound as claimed in claim 24 for treating metals.
